(19) United States
(12) Patent Application Publication
(10) Pub. No.: US 2026/0124110 A1
(43) Pub. Date: May 7, 2026

(54) WOOD BURNING SAUNA STOVE

(71) Applicant: Daryl Lamppa, Tower, MN (US)

(72) Inventor: Daryl Lamppa, Tower, MN (US)

(21) Appl. No.: 18/940,340

(22) Filed: Nov. 7, 2024

(51) Int. Cl. A61H 33/06; F24B 1/02; F24B 13/00

(52) U.S. Cl. CPC A61H 33/063; F24B 1/02; F24B 13/004; A61H 2033/061

(57) ABSTRACT

A wood burning sauna stove includes an outer frame and a firebox inside the outer frame. The outer frame includes an upper frame wall, a front frame wall, a rear frame wall, and lateral frame walls connecting the front frame wall and the rear frame wall. The upper frame wall is designed to support sauna rocks. The firebox includes an upper firebox wall, a lower firebox wall, and a perimeter firebox wall. The perimeter firebox wall includes front, rear, and side firebox walls. An exhaust conduit is positioned between the upper frame wall and the upper firebox wall to heat the upper frame wall and the sauna rocks on the upper frame wall. The exhaust conduit has an exhaust inlet aperture in the upper firebox wall adjacent the front firebox wall and an exhaust outlet aperture in the upper frame wall adjacent the rear firebox wall.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to woodburning stoves and more particularly pertains to a new wood burning sauna stove for smokeless heating of a sauna room. Wood burning stoves produce airborne pollutants in the form of smoke and combustion gases, which are generally undesirable and especially so in urban areas. The wood burning sauna stove is designed to promote complete combustion and smokeless operation. The wood burning sauna stove is designed to hold and heat sauna rocks on top of the wood burning sauna stove for use in creating steam in a sauna room.

### (2) Description of Related Art including information disclosed under 37 CFR 1.97 and 1.98.

The prior art relates to wood burning stoves for heating sauna rooms that generate smoke during operation. The prior art, as best understood, does not disclose a wood burning sauna stove that promotes complete combustion and smokeless operation by including various deflectors, baffles, and diffuser panels that cause turbulent flow of air and exhaust gases inside the wood burning sauna stove. An exhaust conduit is positioned between an upper frame wall of an outer frame and an upper firebox wall of a firebox inside the outer frame to heat the upper frame wall and the sauna rocks on the upper frame wall. The exhaust conduit has an exhaust inlet aperture in the upper firebox wall adjacent the front of the firebox and an exhaust outlet aperture in the upper frame wall adjacent the rear of the firebox, which creates a flow of exhaust gases from front to back underneath sauna rocks on top of the upper frame wall.

### (h) BRIEF SUMMARY OF THE INVENTION

An embodiment of the disclosure meets the needs presented above in a wood burning sauna stove generally comprising an outer frame, a firebox, an exhaust conduit, an ashpan, and a door. The outer frame includes an upper frame wall, a front frame wall, a rear frame wall, and lateral frame walls connecting the front frame wall and the rear frame wall. The upper frame wall is designed to support sauna rocks. The firebox is positioned within the outer frame. The firebox includes an upper firebox wall, a lower firebox wall, and a perimeter firebox wall connecting the lower firebox wall and the upper firebox wall. The perimeter firebox wall includes a front firebox wall, a rear firebox wall, and side firebox walls. The front firebox wall has an opening therein to permit access to an interior of the firebox. The lower firebox wall includes a grate to permit passage of ash out of the firebox. The exhaust conduit is positioned between the upper frame wall and the upper firebox wall to heat the upper frame wall and the sauna rocks on the upper frame wall. The exhaust conduit has an exhaust inlet aperture in the upper firebox wall adjacent the front firebox wall and an exhaust outlet aperture in the upper frame wall adjacent the rear firebox wall. The ashpan assembly is positioned below and connected to the firebox to collect ashes from the firebox. The door is positioned in the front frame wall over the opening in the front firebox wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a wood burning sauna stove according to an embodiment of the disclosure.

FIG. 2 is a front view of an embodiment of the disclosure.

FIG. 3 is a cross-sectional view of the embodiment of the disclosure in FIG. 2.

FIG. 4 is a close-up view of the circled portion of the embodiment of the disclosure in FIG. 3.

FIG. 5 is a cross-sectional view of the embodiment of the disclosure in FIG. 3.

FIG. 6 is an exposed partial perspective view of an embodiment of the disclosure.

FIG. 7 is a perspective view of components of an embodiment of the disclosure.

FIG. 8 is a perspective view of an embodiment of the disclosure in use.

### (j) DETAILED DESCRIPTION OF THE INVENTION

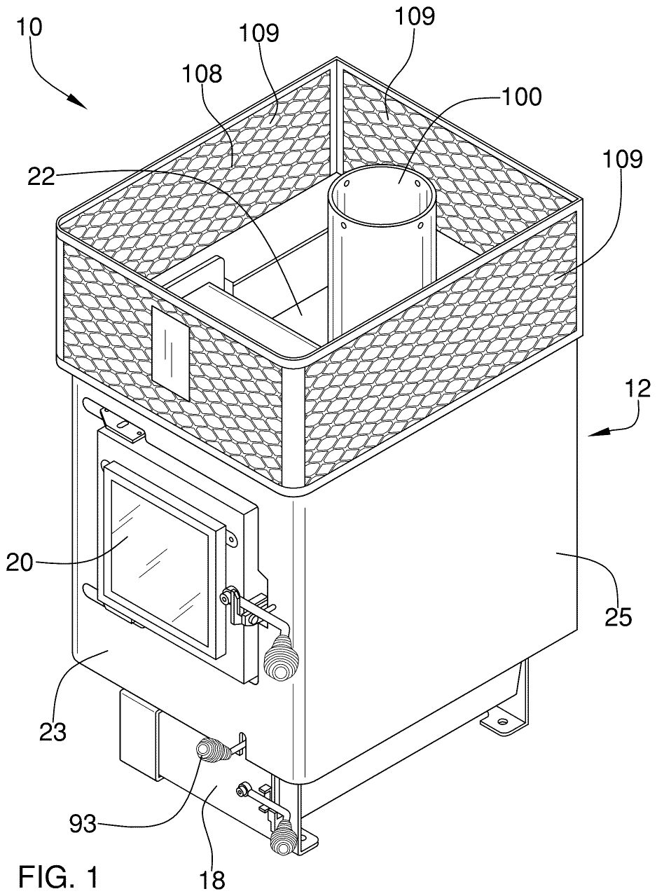

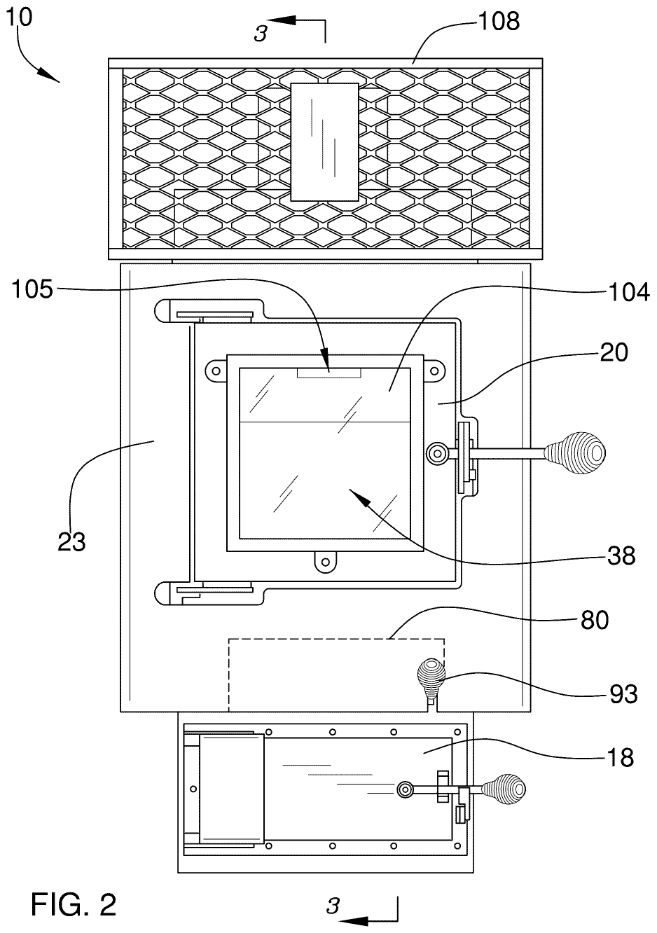

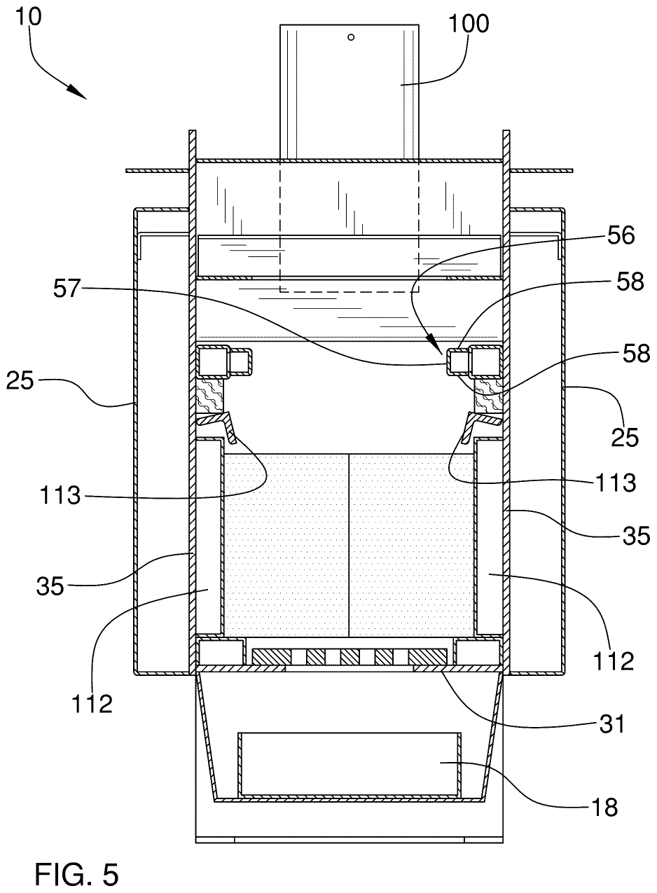

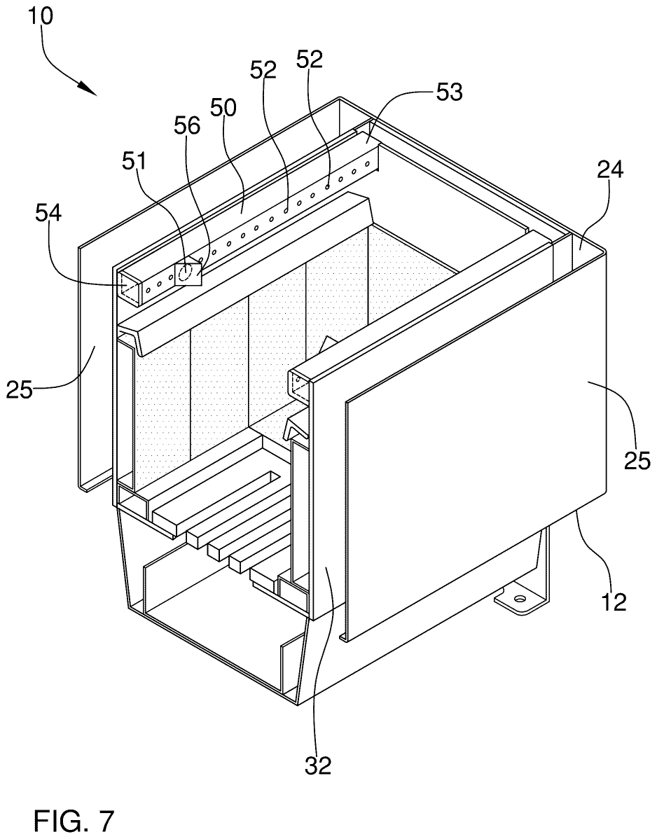

With reference now to the drawings, and in particular to FIGS. 1 through 8 thereof, a new wood burning sauna stove embodying the principles and concepts of an embodiment of the disclosure and generally designated by the reference numeral 10 will be described.

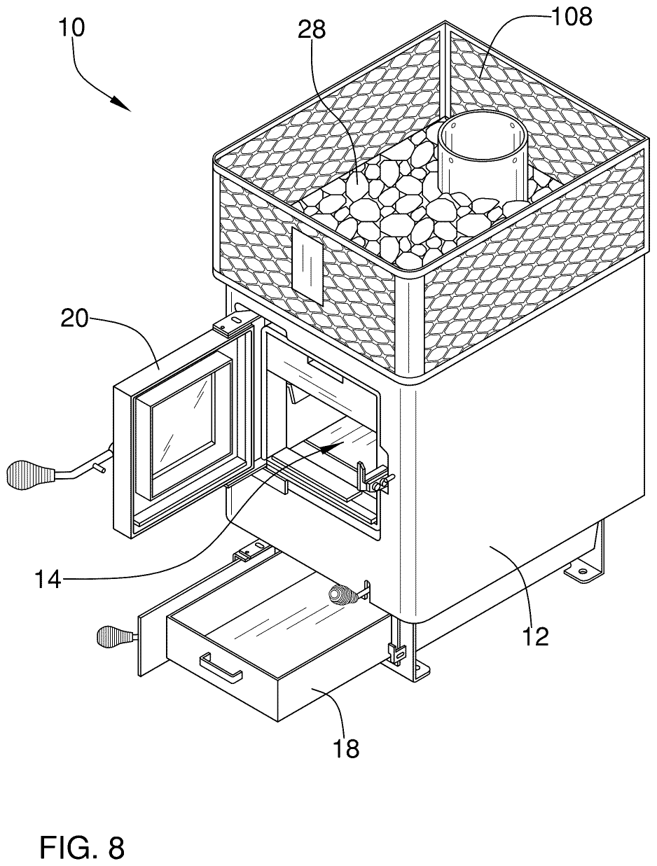

As best illustrated in FIGS. 1 through 8, the wood burning sauna stove 10 generally comprises an outer frame 12, a firebox 14, an exhaust conduit 16, an ashpan assembly 18, and a door 20. The outer frame 12 includes an upper frame wall 22, a front frame wall 23, a rear frame wall 24, and lateral frame walls 25 connecting the front frame wall 23 and the rear frame wall 24. The upper frame wall 22 is designed to support sauna rocks 28, as shown in FIG. 8. The firebox 14 is positioned within the outer frame 12. The firebox 14 includes an upper firebox wall 30, a lower firebox wall 31, and a perimeter firebox wall 32 connecting the lower firebox wall 31 and the upper firebox wall 30. The perimeter firebox wall 32 includes a front firebox wall 33, a rear firebox wall 34, and side firebox walls 35. The front firebox wall 33 has an opening 38 therein to permit access to an interior of the firebox 14. The lower firebox wall 31 includes a grate 40 to permit passage of ash out of the firebox 14. The exhaust conduit 16 is positioned between the upper frame wall 22 and the upper firebox wall 30 to heat the upper frame wall 22 and the sauna rocks 28 on the upper frame wall 22. The exhaust conduit 16 has an exhaust inlet aperture 42 in the upper firebox wall 30 adjacent the front firebox wall 33 and an exhaust outlet aperture 43 in the upper frame wall 22 adjacent the rear firebox wall 34. The ashpan assembly 18 is positioned below and connected to the firebox 14 to collect ashes from the firebox 14. The door 20 is positioned in the front frame wall 23 over the opening 38 in the front firebox wall 33.

It should be noted that the embodiment of the wood burning sauna stove 10 shown in the figures is an exemplary embodiment designed to produce complete combustion and smokeless operation with maximized heat transfer. The various components and arrangement thereof are intended to promote complete combustion and prolong the burning of wood in the wood burning sauna stove 10 via controlled, turbulent air flow, so minor or obvious variations from the design shown in the exemplary embodiment to further enhance such effects are within the scope of the disclosure.

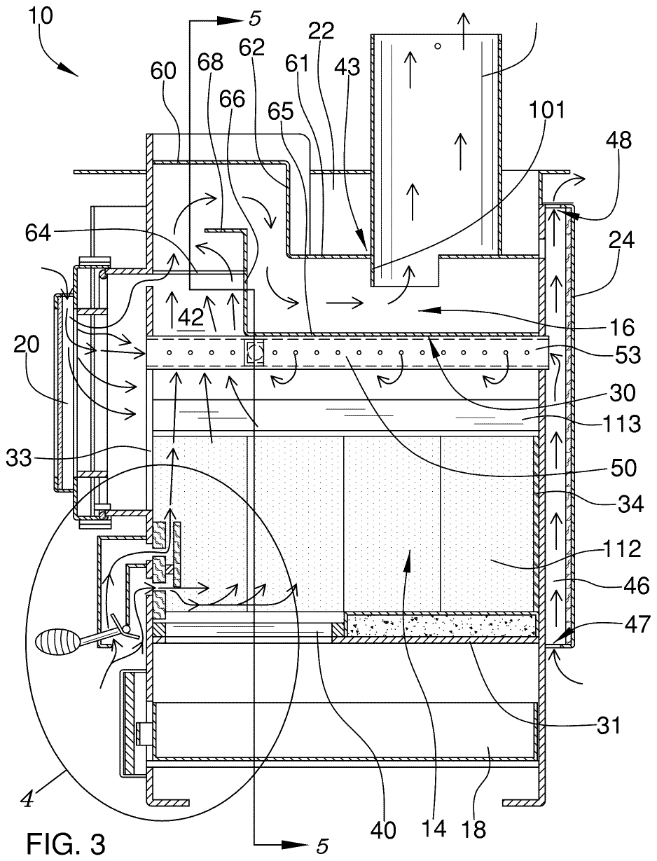

As best seen in FIGS. 3, 6, and 7, the wood burning sauna stove 10 further includes a rear air chamber 46 and a secondary air tube 50 fluidly connected to the rear air chamber 46. The rear air chamber 46 is positioned between the rear frame wall 24 and the rear firebox wall 34. The rear air chamber 46 includes a rear air inlet 47 adjacent the lower firebox wall 31 and a rear air outlet 48 adjacent the upper frame wall 22.

The secondary air tube 50 is mounted adjacent and below the upper firebox wall 30. The secondary air tube 50 extends from the rear air chamber 46 parallel to the upper firebox wall 30. The secondary air tube 50 has a main aperture 51 and plurality of supplemental apertures 52 to permit flow of air out of the secondary air tube 50 and into the firebox 14. The secondary air tube 50 includes an angled deflector 56 projecting outwardly over the main aperture 51 to deflect air exiting the main aperture 51 in a direction back toward the rear firebox wall 34 to cause turbulent flow of the air in the firebox 14. The inventors surprisingly found that the inclusion of the deflector 56 caused increased turbulence and resulting residence time of the air and combustion gases inside the firebox 14 to help promote complete combustion.

In the exemplary embodiment, the main aperture 51 has a larger diameter than each of the supplemental apertures 52. In one possible embodiment, the main aperture 51 is about 0.75 of an inch, and the supplemental apertures 52 are about 0.1875 of an inch or smaller. The larger diameter increases the volume of air that is deflected backwards by the deflector 56. The angled deflector 56 includes a deflector panel 57 angled with respect to an outer surface of the secondary air tube 50 and two triangular side panels 58 connecting the deflector panel 57 to the outer surface. Other shapes, such as square or curved panels, are within the scope of the disclosure. The secondary air tube 50 includes an open end 53 connected to the rear air chamber 46 and a closed end 54 positioned opposite the open end 53 and adjacent the door 20. The closed end 54 prevents air from flowing directly out of the secondary air tube 50 and promotes turbulent flow through the main aperture 51 and the supplemental apertures 52.

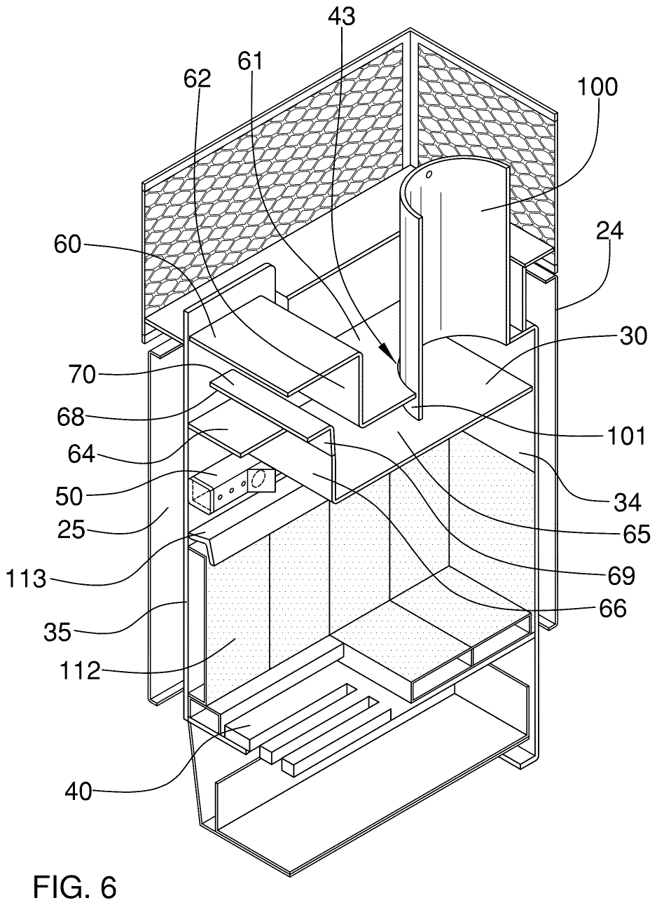

The exhaust conduit 16 is designed to create a turbulent air flow that causes the very hot exhaust gases to reside in the exhaust conduit 16 for longer periods of time than with non-turbulent conduits. As best seen in FIGS. 3 and 6, the upper frame wall 22 is in the form of an S-shaped bracket having: an upper frame panel 60 positioned above the exhaust inlet aperture 42, a lower frame panel 61 positioned about the exhaust outlet aperture 43, and a vertical frame panel 62 connecting the upper frame panel 60 and the lower frame panel 61 to cause turbulent flow of the exhaust gases in the exhaust conduit 16. The upper firebox wall 30 is in the form of an S-shaped bracket having: an upper wall panel 64 about the exhaust inlet aperture 42, a lower wall panel 65, and a vertical wall panel 66 connecting the upper wall panel 64 and the lower wall panel 65. The upper frame wall 22 and the upper firebox wall 30 therefore have generally similar shapes to define the snaking path of exhaust gases through the exhaust conduit 16. This design prevents the exhaust gases from escaping quickly out through the exhaust conduit 16, but rather forces the exhaust gases to swirl around in a turbulent manner inside the exhaust conduit 16. Since hotter gases rise, the hottest portion of the exhaust gases circulates at the upper frame wall 22, thereby promoting transfer of substantial amounts of heat to the upper frame wall 22 and the sauna rocks 28 thereon. For example, exhaust gases travel quickly upwardly through the exhaust inlet aperture 42 toward the upper frame panel 60, at which point the exhaust gases contact the upper frame panel 60 and the vertical frame panel 62 and are deflected back in a turbulent manner, which causes the hottest exhaust to reside longer adjacent the upper frame panel 60 and the vertical frame panel 62 to more effectively heat the upper frame wall 22.

The upper firebox wall 30 also includes an L-shaped bracket 68 having a vertical bracket portion 69 projecting from the vertical wall panel 66 and a horizontal bracket portion 70 projecting over the exhaust inlet aperture 42 to cause turbulent flow of the exhaust gases in the exhaust conduit 16. In one possible embodiment, the L-shaped bracket 68 could possibly be omitted or altered in shape, such as a flat piece oriented vertically or at an angle.

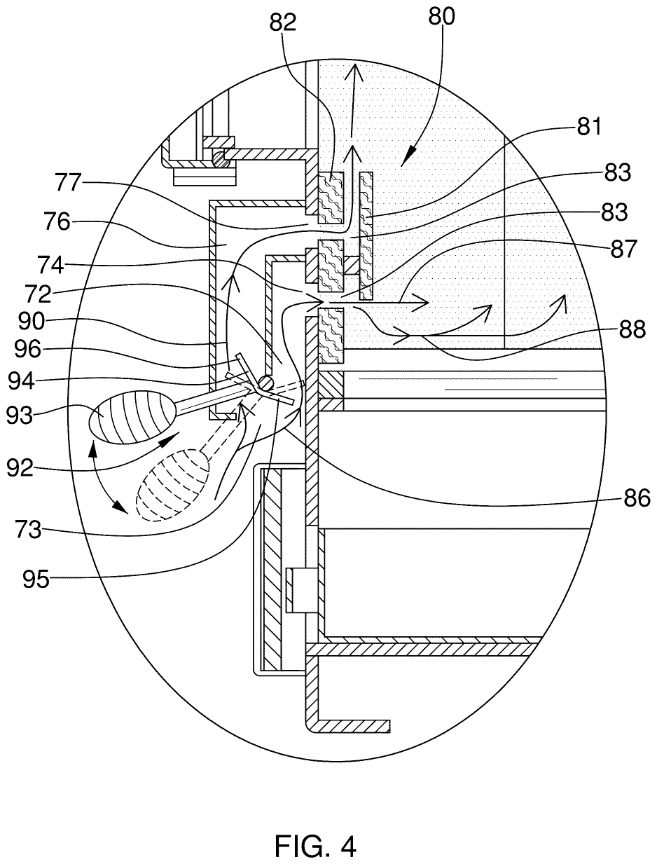

As best seen in FIGS. 3 and 4, a primary air conduit 72 is positioned between the front frame wall 23 and the front firebox wall 33 below the door 20. The primary air conduit 72 has a primary air inlet 73 in the front frame wall 23 and a primary air outlet 74 in the front firebox wall 33.

A diffuser panel 80 is mounted on the front firebox wall 33 adjacent the primary air conduit 72. The diffuser panel 80 extends partially over the primary air outlet 74 to permit a first portion 87 of incoming primary air 86 to travel freely parallel to the lower firebox wall 31 straight into wood in the firebox 14 and deflect a second portion 88 of the incoming primary air 86 downwardly toward an underside of the wood, as shown by the arrows in FIG. 4. The straight air flow is useful for feeding more air directly into the wood for faster combustion to stoke the fire faster, such as at initial starting of a burn. The deflected air flow is useful for maintaining a slower burn once the fire has started.

A secondary air conduit 76 is positioned adjacent the primary air conduit 72 between the front frame wall 23 and the front firebox wall 33 below the door 20. The secondary air conduit 76 is fluidly connected to the primary air inlet 73 to divide incoming air into the incoming primary air 86 and incoming secondary air 90. The secondary air conduit 76 has a secondary air outlet 77 in the front firebox wall 33 above the primary air outlet 74. The diffuser panel 80 extends completely over the secondary air outlet 77 to deflect incoming secondary air 90 upwardly parallel to the front firebox wall 33.

A damper 92 includes a manual lever 93 and a damper cover 94 pivotably mounted adjacent the primary air inlet 73 to control flow of incoming air through the primary air conduit 72 and the secondary air conduit 76. The damper cover 94 has a first portion 95 sufficiently large to completely block the primary air conduit 72 and a second portion 96 sufficiently small to not completely block the secondary air conduit 76 when the damper cover 94 is pivoted to a closed position. For example, as shown in dotted lines in FIG. 4, the damper cover 94 can be pivoted such that the first portion 95 abuts against the front firebox wall 33 to block the primary air conduit 72, but the second portion 96 is unable to contact the front frame wall 23, leaving a clearance therebetween. The clearance could be about 0.25 of an inch, though the exact clearance can be varied depending on desired flow characteristics.

In the exemplary embodiment, the diffuser panel 80 includes a front diffuser wall 81 and a rear diffuser wall 82. The front diffuser wall 81 has diffuser openings 83 that narrow the path from the primary air outlet 74 and the secondary air outlet 77, though these diffuser openings 83 could be the same size as the primary air outlet 74 and the secondary air outlet 77. In one possible embodiment, the diffuser openings 83 are 0.25 inch, and the rear diffuser wall 82 projects 0.1875 of an inch over its corresponding one of the diffuser openings 83. The result is that the first portion 87 of incoming primary air 86 travels through a 0.0625 of an inch space, which creates a higher pressure but restricted amount of air flowing straight into the wood to stimulate faster ignition and burning of the wood.

As best seen in FIGS. 1, 3, 5, and 6, an exhaust pipe 100 is connected to and extends vertically from the upper frame panel 60 at the exhaust outlet aperture 43. The exhaust pipe 100 includes a projecting portion 101 positioned to project partially into the exhaust conduit 16 below the upper frame wall 22 to deflect a portion of the exhaust gases downwardly to cause turbulent flow of the exhaust gases in the exhaust conduit 16. The projecting portion 101 is a convex panel curved outwardly toward the front frame wall 23 and extends about halfway around the circumference of the exhaust outlet aperture 43. In one possible embodiment, the projecting portion 101 could be designed to extend further or less than halfway around the circumference of the exhaust outlet aperture 43.

As best seen in FIGS. 1, 2, and 8, a baffle plate 104 is positioned in the opening 38 in the front firebox wall 33. The baffle plate 104 obstructs an upper portion of the opening 38 to deflect air passing through a door 20 air inlet in the door 20 to cause turbulent flow of air behind the door 20. The baffle plate 104 includes an air slot 105 positioned adjacent an upper edge of the opening 38 in the front firebox wall 33 to permit passage of air to the exhaust conduit 16, though this air slot 105 could be omitted in another possible embodiment.

A perimeter storage wall 108 extends vertically from the outer frame 12 to hold sauna rocks 28 on the upper frame wall 22. The perimeter storage wall 108 includes a plurality of wall openings 109 arranged in a pattern. The perimeter wall could be in the form of metal fencing or lattice work. The perimeter wall could have a decorative design for aesthetic effect.

The wood burning sauna stove 10 can utilize insulating bricks 112 that are held in place by a retainer bracket 113 to line the firebox 14. Other insulating materials can also be used as are well known in the heating arts. The different panels and walls can be made out of metal, such as metal with a high temperature resistance. For example, some of the panels and walls, especially those in direct contact with flames and hot combustion or exhaust gases, can be made of 310 stainless steel, which is designed to withstand temperatures of 2200° C. Other heat-resistant metals and metal alloys could also be used as are well known in the wood burning and heating arts.

The wood burning sauna stove 10 is operated like most conventional wood burning stoves, though the design results in virtually smokeless operation due to complete combustion, which permits use of the wood burning sauna stove 10 in even urban environments or places with tight environmental restrictions. Wood is placed inside the firebox 14 and lit. Because of the controlled air flow and turbulent air flow, the wood burns from front to back and extends the duration of the burn, as well as promotes complete combustion. When steam is desired, water can be poured over the hot sauna rocks 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wood burning sauna stove comprising:
an outer frame including an upper frame wall, a front frame wall, a rear frame wall, and lateral frame walls connecting said front frame wall and said rear frame wall, said upper frame wall being configured to support sauna rocks;
a firebox being disposed within said outer frame, said firebox including an upper firebox wall, a lower firebox wall, and a perimeter firebox wall connecting said lower firebox wall and said upper firebox wall, said perimeter firebox wall including a front firebox wall, a rear firebox wall, and side firebox walls, said front firebox wall having an opening therein to permit access to an interior of said firebox, said lower firebox wall including a grate to permit passage of ash out of said firebox;
an exhaust conduit being disposed between said upper frame wall and said upper firebox wall to heat the upper frame wall and the sauna rocks on said upper frame wall, said exhaust conduit has an exhaust inlet aperture in said upper firebox wall adjacent said front firebox wall and an exhaust outlet aperture in said upper frame wall adjacent said rear firebox wall;
an ashpan assembly being disposed below and connected to said firebox to collect ashes from said firebox; and
a door being positioned in said front frame wall over said opening in said front firebox wall.

2. The wood burning sauna stove of claim 1, further comprising:
a primary air conduit being disposed between said front frame wall and said front firebox wall below said door, said primary air conduit having a primary air inlet in said front frame wall and a primary air outlet in said front firebox wall; and
a diffuser panel being mounted on said front firebox wall adjacent said primary air conduit, said diffuser panel extending partially over said primary air outlet to permit a first portion of incoming primary air to travel freely parallel to said lower firebox wall straight into wood in said firebox and deflect a second portion of the incoming primary air downwardly toward an underside of the wood.

3. The wood burning sauna stove of claim 2, further comprising a secondary air conduit being disposed adjacent said primary air conduit between said front frame wall and said front firebox wall below said door, said secondary air conduit being fluidly connected to said primary air inlet to divide incoming air into incoming primary air and incoming secondary air, said secondary air conduit having a secondary air outlet in said front firebox wall above said primary air outlet.

4. The wood burning sauna stove of claim 3, wherein said diffuser panel extends completely over said secondary air outlet to deflect incoming secondary air upwardly parallel to said front firebox wall.

5. The wood burning sauna stove of claim 3, further comprising a damper including a manual lever and a damper cover pivotably mounted adjacent said primary air inlet to control flow of incoming air through said primary air conduit and said secondary air conduit.

6. The wood burning sauna stove of claim 5, wherein said damper cover has a first portion sufficiently large to completely block said primary air conduit and a second portion sufficiently small to not completely block said secondary air conduit when said damper cover is pivoted to a closed position.

7. The wood burning sauna stove of claim 1, wherein said upper frame wall is in the form of an S-shaped bracket having:
an upper frame panel disposed above said exhaust inlet aperture;
a lower frame panel disposed about said exhaust outlet aperture; and
a vertical frame panel connecting said upper frame panel and said lower frame panel to cause turbulent flow of the exhaust gases in said exhaust conduit.

8. The wood burning sauna stove of claim 7, wherein said upper firebox wall is in the form of an S-shaped bracket having:
an upper wall panel about said exhaust inlet aperture;
a lower wall panel; and
a vertical wall panel connecting said upper wall panel and said lower wall panel.

9. The wood burning sauna stove of claim 8, wherein said upper firebox wall includes an L-shaped bracket having a vertical bracket portion projecting from said vertical wall panel and a horizontal bracket portion projecting over said exhaust inlet aperture to cause turbulent flow of the exhaust gases in said exhaust conduit.

10. The wood burning sauna stove of claim 1, further comprising an exhaust pipe being connected to and extending vertically from said upper frame panel at said exhaust outlet aperture, said exhaust pipe includes a projecting portion disposed to project partially into said exhaust conduit below said upper frame wall to deflect a portion of the exhaust gases downwardly to cause turbulent flow of the exhaust gases in said exhaust conduit.

11. The wood burning sauna stove of claim 10, wherein said projecting portion is a convex panel curved outwardly toward said front frame wall and extending about halfway around the circumference of said exhaust outlet aperture.

12. The wood burning sauna stove of claim 1, further comprising a rear air chamber and a secondary air tube fluidly connected to said rear air chamber, wherein:
said rear air chamber is disposed between said rear frame wall and said rear firebox wall, said rear air chamber includes a rear air inlet adjacent said lower firebox wall and a rear air outlet adjacent said upper frame wall; and
said secondary air tube is mounted adjacent and below said upper firebox wall, said secondary air tube extends from said rear air chamber parallel to said upper firebox wall, said secondary air tube has a main aperture and plurality of supplemental apertures to permit flow of air out of said secondary air tube and into said firebox, said secondary air tube includes an angled deflector projecting outwardly over said main aperture to deflect air exiting said main aperture in a direction back toward said rear firebox wall to cause turbulent flow of the air in said firebox.

13. The wood burning sauna stove of claim 12, wherein said main aperture has a larger diameter than each of said supplemental apertures.

14. The wood burning sauna stove of claim 12, wherein said angled deflector includes a deflector panel angled with respect to an outer surface of said secondary air tube and two triangular side panels connecting said deflector panel to said outer surface.

15. The wood burning sauna stove of claim 12, wherein said secondary air tube includes an open end connected to said rear air chamber and a closed end opposite said open end and adjacent said door.

16. The wood burning sauna stove of claim 1, further comprising a baffle plate being disposed in said opening in said front firebox wall, said baffle plate obstructs an upper portion of said opening to deflect air passing through a door air inlet in said door to cause turbulent flow of air behind said door.

17. The wood burning sauna stove of claim 16, wherein said baffle plate includes an air slot disposed adjacent an upper edge of said opening in said front firebox wall to permit passage of air to said exhaust conduit.

18. The wood burning sauna stove of claim 1, further comprising a perimeter storage wall extending vertically from said outer frame to hold sauna rocks on said upper frame wall, said perimeter storage wall including a plurality of wall openings arranged in a pattern.

19. The wood burning sauna stove of claim 1, wherein:
the wood burning sauna stove further comprises a rear air chamber and a secondary air tube fluidly connected to said rear air chamber;
said rear air chamber is disposed between said rear frame wall and said rear firebox wall, said rear air chamber includes a rear air inlet adjacent said lower firebox wall and a rear air outlet adjacent said upper frame wall;
said secondary air tube is mounted adjacent and below said upper firebox wall, said secondary air tube extends from said rear air chamber parallel to said upper firebox wall, said secondary air tube has a main aperture and plurality of supplemental apertures to permit flow of air out of said secondary air tube and into said firebox, said secondary air tube includes an angled deflector projecting outwardly over said main aperture to deflect air exiting said main aperture in a direction back toward said rear firebox wall to cause turbulent flow of the air in said firebox;
said main aperture has a larger diameter than each of said supplemental apertures;
said angled deflector includes a deflector panel angled with respect to an outer surface of said secondary air tube and two triangular side panels connecting said deflector panel to said outer surface;
said secondary air tube includes an open end connected to said rear air chamber and a closed end opposite said open end and adjacent said door;
said upper frame wall is in the form of an S-shaped bracket having:
an upper frame panel disposed above said exhaust inlet aperture;
a lower frame panel disposed about said exhaust outlet aperture; and
a vertical frame panel connecting said upper frame panel and said lower frame panel to cause turbulent flow of the exhaust gases in said exhaust conduit;
said upper firebox wall is in the form of an S-shaped bracket having:
an upper wall panel about said exhaust inlet aperture;
a lower wall panel; and
a vertical wall panel connecting said upper wall panel and said lower wall panel; and
said upper firebox wall includes an L-shaped bracket having a vertical bracket portion projecting from said vertical wall panel and a horizontal bracket portion projecting over said exhaust inlet aperture to cause turbulent flow of the exhaust gases in said exhaust conduit.

20. The wood burning sauna stove of claim 19, wherein further comprising:
a primary air conduit being disposed between said front frame wall and said front firebox wall below said door, said primary air conduit having a primary air inlet in said front frame wall and a primary air outlet in said front firebox wall;
a diffuser panel being mounted on said front firebox wall adjacent said primary air conduit, said diffuser panel extending partially over said primary air outlet to permit a first portion of incoming primary air to travel freely parallel to said lower firebox wall straight into wood in said firebox and deflect a second portion of the incoming primary air downwardly toward an underside of the wood;
a secondary air conduit being disposed adjacent said primary air conduit between said front frame wall and said front firebox wall below said door, said secondary air conduit being fluidly connected to said primary air inlet to divide incoming air into incoming primary air and incoming secondary air, said secondary air conduit having a secondary air outlet in said front firebox wall above said primary air outlet, said diffuser panel extending completely over said secondary air outlet to deflect incoming secondary air upwardly parallel to said front firebox wall;
a damper including a manual lever and a damper cover pivotably mounted adjacent said primary air inlet to control flow of incoming air through said primary air conduit and said secondary air conduit, wherein said damper cover has a first portion sufficiently large to completely block said primary air conduit and a second portion sufficiently small to not completely block said secondary air conduit when said damper cover is pivoted to a closed position;
an exhaust pipe being connected to and extending vertically from said upper frame panel at said exhaust outlet aperture, said exhaust pipe includes a projecting portion disposed to project partially into said exhaust conduit below said upper frame wall to deflect a portion of the exhaust gases downwardly to cause turbulent flow of the exhaust gases in said exhaust conduit, wherein said projecting portion is a convex panel curved outwardly toward said front frame wall and extending about halfway around the circumference of said exhaust outlet aperture;
a baffle plate being disposed in said opening in said front firebox wall, said baffle plate obstructs an upper portion of said opening to deflect air passing through a door air inlet in said door to cause turbulent flow of air behind said door, wherein said baffle plate includes an air slot disposed adjacent an upper edge of said opening in said front firebox wall to permit passage of air to said exhaust conduit; and
a perimeter storage wall extending vertically from said outer frame to hold sauna rocks on said upper frame wall, said perimeter storage wall including a plurality of wall openings arranged in a pattern.
